(19) United States
(12) Patent Application Publication
(10) Pub. No.: US 2023/0339622 A1
(43) Pub. Date: Oct. 26, 2023

(54) Methods and Devices for Measurement of Aircraft Takeoff and Landing Performance

(71) Applicants: Charles Gordon Horrell, Lyme, NH (US); Erik Christopher Chubb, Alameda, CA (US)

(72) Inventors: Charles Gordon Horrell, Lyme, NH (US); Erik Christopher Chubb, Alameda, CA (US)

(21) Appl. No.: 18/305,357

(22) Filed: Apr. 23, 2023

Related U.S. Application Data
(60) Provisional application No. 63/334,162, filed on Apr. 24, 2022.

(51) Int. Cl. B64D 45/00; G01S 19/15

(52) U.S. Cl. CPC B64D 45/00; G01S 19/15

(57) ABSTRACT

Apparatus and methods are presented for providing pilots feedback on takeoff and landing performance. The apparatus includes a means for determining the length of the takeoff roll, the length of the landing roll, and the accuracy of the touch-down point as compared to a fixed target point on the landing surface. These performance parameters are reported to the pilot through an onboard interface such as a smartphone or tablet.

### RELATED APPLICATION DATA

The present application claims benefit of co-pending provisional application Ser. No. 63/334,162, filed Apr. 24, 2022, the entire disclosure of which is expressly incorporated by reference herein.

### FIELD OF THE INVENTION

The present invention relates to apparatus and methods for pilot training and evaluation. More specifically, certain embodiments relate to systems and methods for measuring parameters associated with the takeoff and landing portions of flight.

### BACKGROUND

In general, the most challenging parts of piloting are managing the takeoff and landing phases of flight. The proximity to the ground and spatial constraints associated with the runway and runway environment make it very important for a pilot to maximize the performance of the aircraft and control it as accurately as possible.

In the general aviation world, pilot performance is commonly judged based upon the efficient and accurate use of runway length, which can sometimes be limited. When runway length is a constraint, optimizing the takeoff generally means taking off in as short a distance as possible and then quickly climbing to a safe altitude. Optimizing the landing generally means accurately touching down as close as possible to the threshold of the runway (or the aiming point if the runway has a displaced threshold) and then stopping the aircraft as quickly as possible.

A lot of the training that goes into the early stages of a pilot's training centers around the takeoff and landing phases of flight. A large part of transition training, in which a pilot who is proficient in one type of aircraft learns to fly a new aircraft, consists of learning to accurately take off and land the new aircraft type. Most check-rides that must be completed with an FAA designated examiner include demonstrating optimal takeoff and landing mastery.

A good pilot is constantly evaluating their performance, and having the right tools to do so allows them to continually improve. Accordingly, apparatus and methods for providing pilot feedback and training would be useful.

### SUMMARY

The present invention is intended to provide a feedback tool to pilots who are practicing their takeoff and landing technique. The present invention is directed to apparatus and methods for measuring the takeoff and landing performance of an aircraft and its pilot.

In accordance with one embodiment, an apparatus is provided for detecting certain parameters associated with a completed takeoff or landing and communicating those parameters to the pilot. In this embodiment the takeoff or landing may be detected using an external sensor unit attached to the aircraft that is continually measuring its distance from the surface of the runway using a LiDAR sensor. In this embodiment the LiDAR data is communicated via a wireless connection to an interface device in the cockpit that is visible to the user. Further, the interface device may be a device such as a smartphone or tablet that has built-in GPS capability.

In accordance with this embodiment, a method is provided for determining takeoff and landing performance by combining height above runway data from the external sensor unit attached to the aircraft with GPS data from the interface device in the cockpit. Comparison of the takeoff or touchdown point to a user-set target landing point yields a meaningful measure of takeoff and landing performance.

In accordance with another embodiment, takeoff and landing could be detected using an ultrasonic or radar sensor or other means of distance measurement in the external sensor unit.

In accordance with another embodiment, takeoff and landing could be detected using a distance measurement not to the runway surface but to the landing gear, which in flight will consistently be at its lowest travel (full droop).

In accordance with another embodiment, takeoff and landing could be detected using a limit switch on the landing gear.

In accordance with another embodiment, takeoff and landing could be detected using a vibration sensor in the external sensor unit or in the interface device in the cockpit that detects a change in aircraft vibration when the wheels depart or contact the runway.

In accordance with another embodiment, takeoff and landing as well as distance traveled could be detected by measuring wheel speed and counting revolutions of the tire.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIG. 1 is a flow chart showing the sequence of events that the apparatus completes to provide feedback to the user.

FIG. 2 is a block diagram showing how the different parts of the system interface with each other.

FIG. 3 is an image of the assembled external unit.

FIG. 4 is an image of the dis-assembled external unit, showing the internal components.

FIG. 5 is an image of the adhesive-backed mount used to attach the external unit to the aircraft.

FIG. 6 is a screenshot taken on the interface device.

FIG. 7 is an image showing the external unit mounted on the belly of an aircraft.

### DETAILED DESCRIPTION OF THE EXEMPLARY EMBODIMENTS

Turning to the drawings,

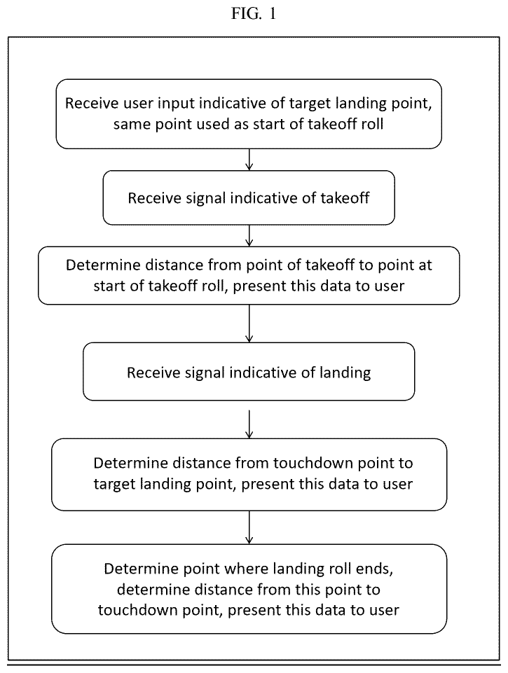

FIG. 1 shows a flow chart describing the sequence of events that make up one cycle of user feedback with the apparatus. The pilot begins by typically lining up the main wheels of the airplane with a visual reference on the runway, such as the leading edge of a centerline stripe, and then presses a button on the interface device indicating that this will be the target landing point. The pilot can then begin his takeoff roll and when the external sensor unit detects that the aircraft has departed the runway it sends this signal to the interface device. The interface device compares the location of this liftoff point to the start of the takeoff roll (at the target point that the user set) and gives the pilot feedback on the length of their takeoff roll. The pilot then maneuvers around the traffic pattern and attempts to land as close as possible to the target point as possible. As soon as the external sensor unit detects the landing it sends this signal to the interface device. Once the pilot has completely stopped the aircraft, the location of the touchdown point, the point at which the aircraft is fully stopped, and the target point are used to give the pilot feedback on the accuracy of their landing and the length of the landing roll.

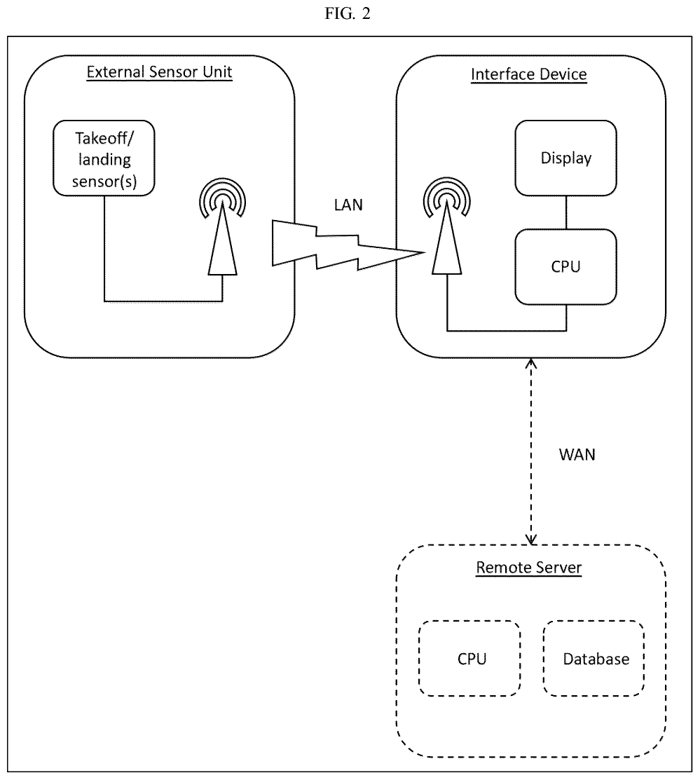

FIG. 2 shows a block diagram depicting how the components of the system work together. In one embodiment the external sensor unit contains the sensor or sensors used to detect the aircraft's takeoff or landing, as well as an onboard battery and means to transmit data to the interface device. This could be as simple as a wired connection, or as depicted in the block diagram it could be a Local Area Network such as a wireless or Bluetooth connection. The interface device receives data from the external sensor unit and can process that data along with any data it generates internally (such as GPS position, acceleration data, etc.) to arrive at feedback to provide to the pilot. This feedback is then presented in terms of a takeoff roll, a landing roll, and a landing accuracy. Alternately, as shown in the block diagram, the interface device could transmit data via a Wide Area Network, using Bluetooth or wireless or cell or satellite technology, to an off site server for evaluation, storage, and/or presentation.

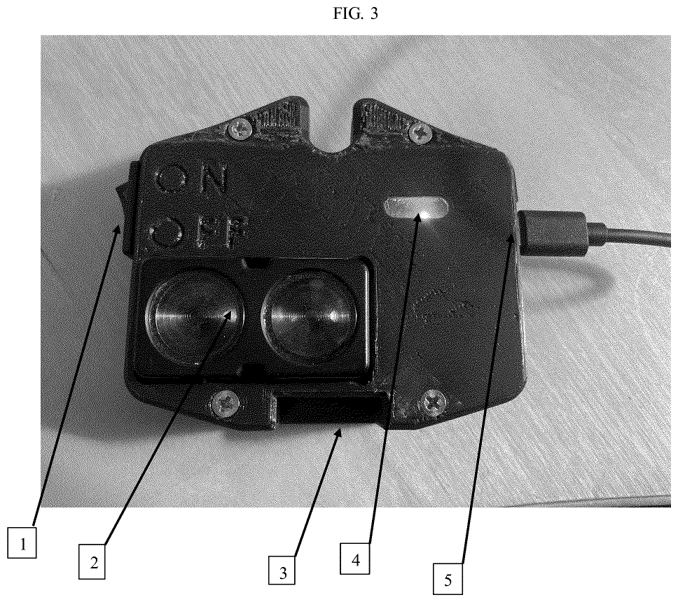

FIG. 3 shows an exemplary embodiment of the assembled external sensor unit. The on-off switch (1) is used to turn the unit on and off for operation. The LiDAR unit (2) measures distance to the surface of the runway. There is a pocket shown (3) that enables attachment to a mount that remains affixed to the aircraft. A charge light (4) indicates when the device is being charged by plugging a USB-C charger into its port (5).

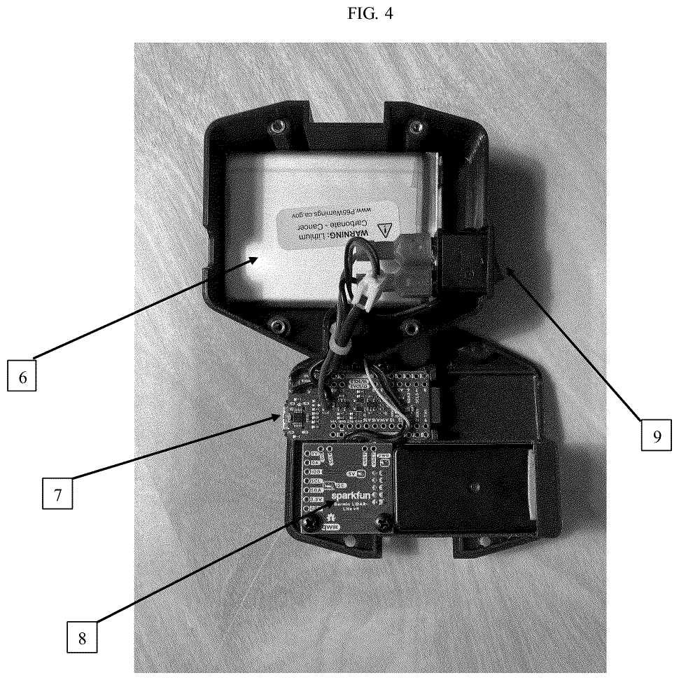

FIG. 4 shows an exemplary embodiment of the disassembled external sensor unit. The LiPo battery (6) is shown and it powers the onboard processor, battery manager, and Bluetooth module (7) as well as the LiDAR unit (8). The on-off switch (9) is also visible.

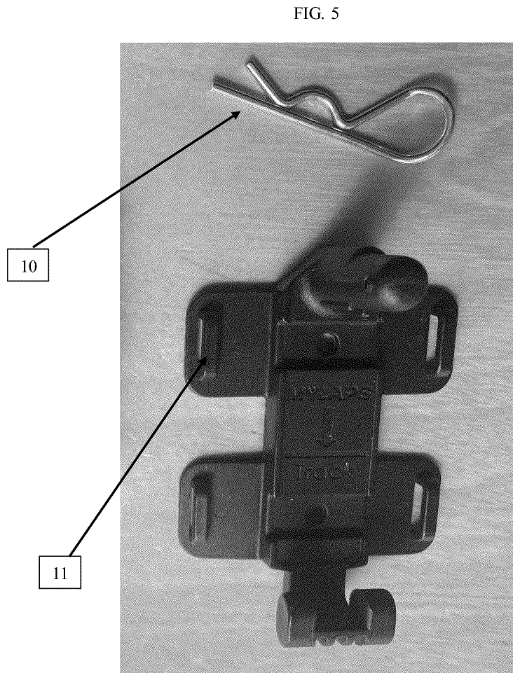

FIG. 5 shows an exemplary embodiment of the adhesive-backed mount (11) that attaches the external sensor unit to the aircraft. Once in place the external sensor unit is locked into position using the clip (10) shown.

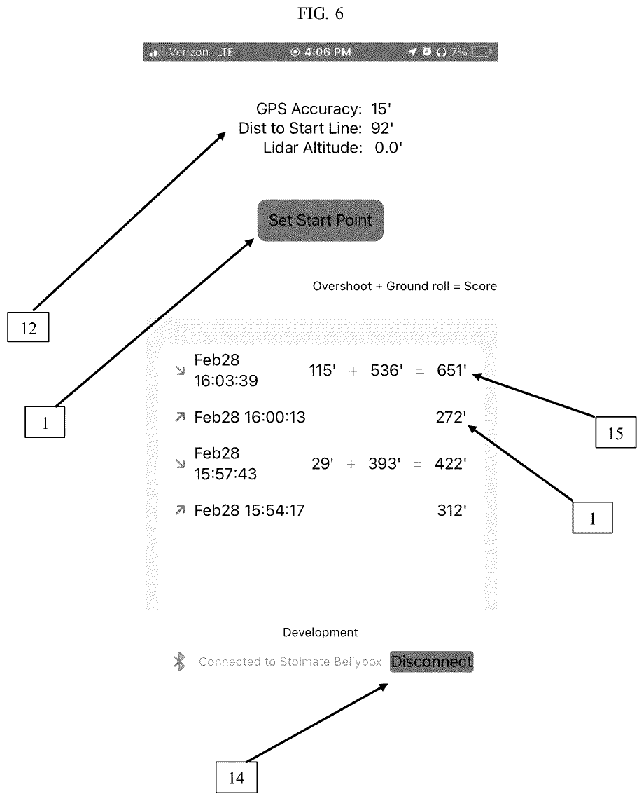

FIG. 6 shows an exemplary embodiment of the screen of the interface device. In this embodiment, there is some basic information that is displayed near the top (12) to help the user determine that the system is functioning well. There is a button shown (13) that the user will press to establish the target point before beginning the takeoff roll (usually near a stripe or other highly-visible marking on the runway). This same point is then used as the target point for the landing. There is a button shown at the bottom of the screen (14) that the user can use to connect and disconnect the interface unit to the external sensor unit using Bluetooth. When a takeoff is completed it is shown as an arrow pointing up to the right, with the time of the takeoff and the length of the takeoff roll shown (16). When a landing is completed, it is shown as an arrow pointing down to the right, with the time of the landing, and then the distance from the touchdown point to the target point, the total landing roll distance, and then a score equal to the sum of these distances (15).

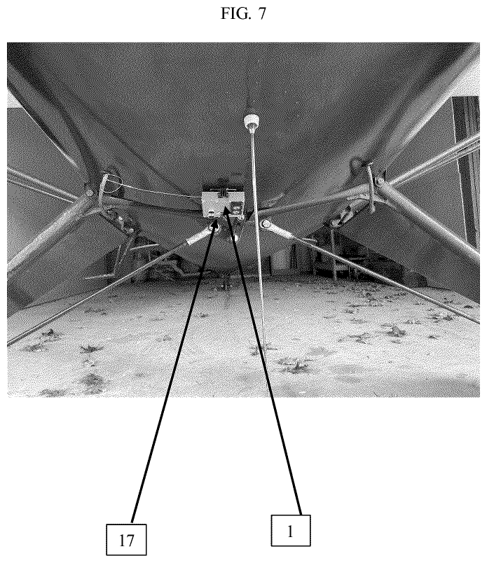

FIG. 7 shows an exemplary embodiment of the external sensor unit (18) mounted to the belly of an aircraft. The clip (17) that secures the external sensor unit to the mount can be seen.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

I/We claim:

1. An apparatus for measuring length of takeoffs/landings of aircraft comprising: means for detecting the takeoff/landing, and means for detecting distance of travel of the aircraft.

2. The apparatus of claim 1, wherein takeoffs and landings are detected by distance measurement from the aircraft to the landing surface.

3. The apparatus of claim 1, wherein takeoffs and landings are detected by observation of the aircraft landing gear or rotation of the wheels/tires of the aircraft.

4. The apparatus of claim 1, wherein takeoffs and landings are detected by observation of acceleration or vibration of the aircraft.

5. The apparatus of claim 1, wherein distance of travel is detected using GPS data.

6. The apparatus of claim 1, wherein distance of travel is detected using observation of the wheels/tires of the aircraft.

7. The apparatus of claim 1, which may also measure accuracy of takeoffs/landings of aircraft comprising: means for detecting the location of takeoff/landing, and means for comparing the takeoff/landing location to a fixed point.

8. The apparatus of claim 7, wherein takeoffs and landings are detected by distance measurement from the aircraft to the landing surface.

9. The apparatus of claim 7, wherein takeoffs and landings are detected by observation of the aircraft landing gear, or rotation of the wheels/tires of the aircraft.

10. The apparatus of claim 7, wherein takeoffs and landings are detected by observation of acceleration or vibration of the aircraft.

11. The apparatus of claim 7, wherein takeoffs and landings are detected using comparison of GPS-derived elevation data to surface elevation data.

12. The apparatus of claim 7, wherein comparing the takeoff/landing location to a fixed point is done using GPS data.

13. A method for measuring length and accuracy of takeoffs/landings of aircraft.

14. The method of claim 13, wherein length of the takeoff is determined by comparing the location of the takeoff point to a fixed starting point.

15. The method of claim 13, wherein length of the landing is determined by comparing the location of the touchdown point to the location at which the aircraft comes to a stop after the landing roll.

16. The method of claim 13, wherein accuracy of the landing is determined by comparing the location of the touchdown point to a fixed target landing point.

17. The method of claim 13, wherein providing feedback to the aircraft operator of takeoff/landing performance parameters is done through an onboard interface device.

18. The method of claim 17, wherein the onboard interface device is a smartphone or tablet.

19. An apparatus for measuring length of takeoffs/landings of an aircraft comprising:
i) an external sensor unit configured to be coupled to the aircraft and to generate a signal indicative of at least one of takeoff and landing of the aircraft, wherein the sensor is configured to communicatively couple to a mobile electronic device;
ii) wherein the mobile electronic device is configured to receive the signal indicative of at least one of takeoff and landing and to display a score indicative of an accuracy and/or length of the takeoff or landing.

20. The apparatus of claim 19, wherein the score comprises at least one of:
(1) a distance from a touchdown point to the point at which the aircraft comes to a complete stop (landing roll);
(2) a distance from a touchdown point to a fixed target point (landing accuracy);
(3) a distance from a takeoff initiation point to a takeoff point (takeoff roll).
